(19) United States
(12) Patent Application Publication
(10) Pub. No.: US 2008/0303821 A1
(43) Pub. Date: Dec. 11, 2008

(54) Graphic processing method and apparatus for supporting line acceleration function

(75) Inventors: Young-Ihn Kho, Seoul (KR); Jeong-hwan Ahn, Suwon-si (KR); Hee-sae Lee, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/010,200

(22) Filed: Jan. 22, 2008

(30) Foreign Application Priority Data
Jun. 11, 2007 (KR) 10-2007-0056752

(51) Int. Cl. G06T 11/20

(52) U.S. Cl. 345/441

(57) ABSTRACT

Provided are a graphic processing method and apparatus supporting a line acceleration function. The graphic processing method includes: transforming at least one line represented by graphic data, to a polygon; and rendering the polygon and at least one polygon represented by the graphic data. Therefore, a graphics chip set which normally supports only a polygon acceleration function can also support a line acceleration function.

### CROSS-REFERENCE TO RELATED PATENT APPLICATION

This application claims the benefit of Korean Patent Application No. 10-2007-0056752, filed on Jun. 11, 2007, in the Korean Intellectual Property Office, the disclosure of which is incorporated herein in its entirety by reference.

### BACKGROUND OF THE INVENTION

1. Field of the Invention

The present invention relates to a method and apparatus for processing graphic data, and more particularly, to a graphic processing method and apparatus for supporting a line acceleration function.

2. Description of the Related Art

In general, a graphic image is comprised of a plurality of polygons and a plurality of lines. Accordingly, graphic data representing a graphic image is comprised of polygonal data representing at least one polygon, and line data representing at least one line. Most graphics cards that are currently available have a hardware acceleration function of rendering polygons and lines by using hardware instead of software. Since a graphics card having the hardware acceleration function renders graphic data using only its internal chip set instead of using a Central Processing Unit (CPU), the graphics card can render graphic data at a high speed.

FIG. 1 is a block diagram of a conventional graphics engine 11 which is installed in a mobile terminal.

Referring to FIG. 1, the graphics engine 11 supports hardware acceleration for polygons, but does not support hardware acceleration for lines. The graphics engine 11 processes lines by using software. In many cases, a device such as a mobile terminal, which requires low-power, minimization, price competitiveness, etc., includes a graphics chip set which does not support the line acceleration function which is less frequently used compared to the polygon acceleration function.

However, since a conventional graphics chip set which supports only the polygon acceleration function processes line data only by using software, a large amount of time is consumed when the graphics chip set renders graphic data containing a large amount of line data, and accordingly, smooth screen reproduction which is required by the mobile terminal user is impossible.

### SUMMARY OF THE INVENTION

The present invention provides a method and apparatus for enabling a graphics chip set supporting only a polygon acceleration function to support a line acceleration function.

The present invention also provides a computer-readable recording medium having embodied thereon a program for executing the method.

According to an aspect of the present invention, there is provided a graphic processing method including: transforming at least one line represented by graphic data, to a polygon; and rendering the polygon and at least one polygon represented by the graphic data.

According to another aspect of the present invention, there is provided a computer-readable recording medium having embodied thereon a program for executing the graphic processing method.

According to another aspect of the present invention, there is provided a graphics processing apparatus including: a line transformation unit transforming at least one line represented by graphic data, to a polygon; and a graphics engine rendering the polygon and at least one polygon represented by the graphic data.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional graphics engine which is installed in a mobile terminal;

FIG. 2 is a block diagram of a graphics processing apparatus according to an embodiment of the present invention;

FIG. 3 is a detailed block diagram of a line transformation unit of the graphics processing apparatus illustrated in FIG. 2;

FIG. 4 is a view for explaining a line transformation method which is performed by a 2-dimensional line transformation unit of the line transformation unit illustrated in FIG. 3, according to an embodiment of the present invention;

FIG. 5 is a view for explaining a method of calculating the coordinate values of a pair of offset points V2+ and V2− for a point V2 among points illustrated in FIG. 4;

FIG. 6 is a view for explaining a method of calculating the coordinate values of a pair of offset points V1+ and V1− for a point V1 among the points illustrated in FIG. 4;

FIG. 7 is a view for explaining a line transformation method which is performed by a 3-dimensional line transformation unit illustrated in FIG. 3;

FIG. 8 is a view for explaining a method of calculating the coordinate values of three points V1+, V1−, and V1* for a point V1 among the points illustrated in FIG. 7;

FIG. 9 is a flowchart of a graphic processing method according to an embodiment of the present invention;

FIG. 10 is a detailed flowchart of operation 92 of the graphic processing method illustrated in FIG. 9; and

FIG. 11 is a detailed flowchart of operation 93 of the graphic processing method illustrated in FIG. 9,

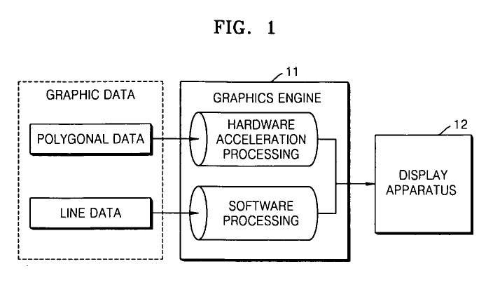

### DETAILED DESCRIPTION OF THE INVENTION

Hereinafter, embodiments of the present invention will be described in detail with reference to the attached drawings.

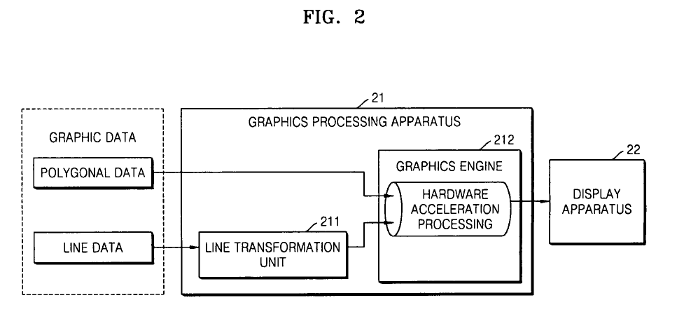

FIG. 2 is a block diagram of a graphics processing apparatus 21 according to an embodiment of the present invention.

Referring to FIG. 2, the graphics processing apparatus 21 according to the current embodiment of the present invention includes a line transformation unit 211 and a graphics engine 212.

The line transformation unit 211 transforms at least one line which is represented by graphic data, into a polygon. In more detail, the line transformation unit 211 connects points that are separated a predetermined distance from each point constructing each line of graphic data, thereby generating a polygon for the line.

The graphics engine 212 renders at least one polygon which is represented by the graphic data and the polygon which is transformed by the line transformation unit 211, and thus generates screen data that is to be output to a display apparatus 22. In the current embodiment of the present invention, rendering refers to an entire process of generating screen data that is to be output to the display apparatus 22, using graphic data. It will be also understood by one of ordinary skill in the art that the rendering can include a Transform and Lighting (T&L) operation of transforming the coordinate system of graphic data and providing a lighting effect to the graphic data, a triangle setup operation of defining the scan lines of triangles each corresponding to a polygon, a rasterization operation of determining pixels that are located inside each triangle, and a rendering operation of determining a color value of each pixel, etc.

In particular, according to the current embodiment of the present invention, the graphics engine 212 renders the at least one polygon represented by the graphic data and the polygon transformed by the line transformation unit 211, through hardware acceleration. Here, the hardware acceleration is a function which is supported by a NVIDIA Geforce Series graphics card or the like. Hardware acceleration refers to high-speed graphic processing, such as rendering, etc., which is performed by a graphics card chip-set, instead of a CPU. In particular, graphics cards that are currently available can support most graphic processing functions which have heretofore been conventionally performed by a CPU.

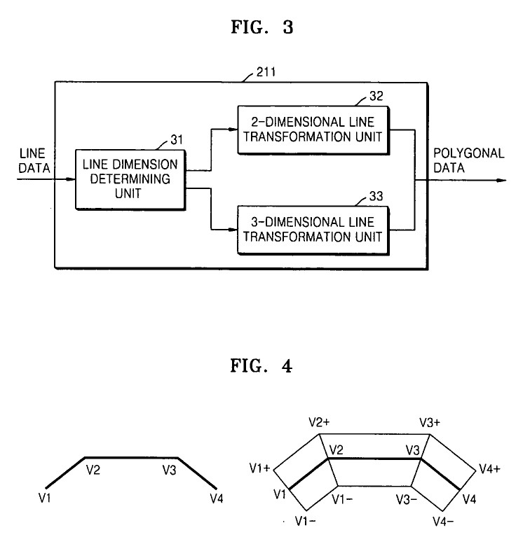

FIG. 3 is a detailed block diagram of the line transformation unit 211 of the graphics processing apparatus 21 illustrated in FIG. 2.

Referring to FIG. 3, the line transformation unit 211 includes a line dimension determining unit 31, a 2-dimensional line transformation unit 32, and a 3-dimensional line transformation unit 33. In the current embodiment, graphic data can represent all of 2-dimensional lines and 3-dimensional lines. For example, graphic data constructing a navigation screen can represent a 2-dimensional image such as a road and a 3-dimensional image such as a building, wherein lines included in the 2-dimensional image are 2-dimensional lines and lines included in the 3-dimensional image are 3-dimensional lines.

The line dimension determining unit 31 determines whether at least one line which is represented by the graphic data is a 2-dimensional line or a 3-dimensional line. In more detail, the line dimension determining unit 31 determines that a line which is represented by the graphic data is a 2-dimensional line, if the geometry data of the line has a 2-dimensional coordinate value, that is, (x, y). Also, the line dimension determining unit 31 determines that a line which is represented by the graphic data is a 3-dimensional line, if the geometry data of the line has a 3-dimensional coordinate value, that is, (x, y, z).

The 2-dimensional line transformation unit 32 transforms a 2-dimensional line of the at least one line represented by the graphic data, into a 2-dimensional polygon, on the basis of the determination result of the line dimension determining unit 31. In more detail, the 2-dimensional line transformation unit 32 connects points that are separated a predetermined distance with respect to two predetermined directions from each point constructing a 2-dimensional line among at least one line which is represented by the graphic data, on the basis of the determination result of the line dimension determining unit 31, thereby generating a polygon for the 2-dimensional line. Here, the two predetermined directions are both directions in which the 2-dimensional line extends.

FIG. 4 is a view for explaining a line transformation method which is performed by the 2-dimensional line transformation unit 32 of the line transformation unit 211 illustrated in FIG. 3.

Referring to FIG. 4, the 2-dimensional line transformation unit 32 calculates the coordinate values of a pair of offset points that are separated a predetermined distance with respect to both directions of a 2-dimensional line from each point constructing the 2-dimensional line. In the current embodiment of the present invention, points constructing the 2-dimensional line are set to points V2 and V3 at which the 2-dimensional line is bent, and end points V1 and V4 of the 2-dimensional line.

Also, the 2-dimensional line transformation unit 32 generating geometry data of a 2-dimensional polygon sequentially connecting points, that is, V1+, V1−, V2+, V2−, V3+, V3−, V4+, and V4−, for each point constructing the 2-dimensional line, using the coordinate values of the points V1+, V1−, V2+, V2−, V3+, V3−, V4+, and V4− that are calculated according to the above-described method. Here, sequentially connecting offset point pairs calculated for each point constructing the 2-dimensional line refers to connecting a pair of offset points calculated for each point constructing the 2-dimensional line, and connecting most-neighboring offset points that are positioned in the same direction.

Hereinafter, a method of calculating the coordinate values of offset point pairs (V1+, V1−) and (V2+, V2−) for the points V1 and V2 among the points V1, V2, V3, and V4 illustrated in FIG. 4 will be described in detail.

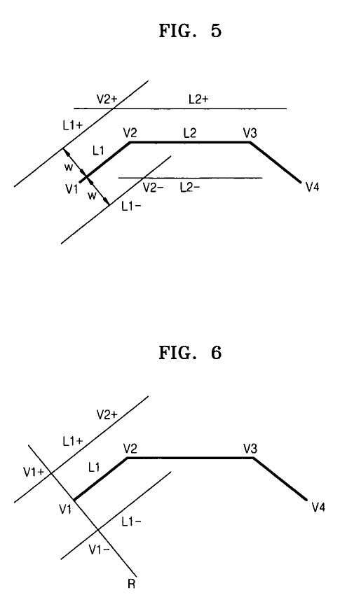

FIG. 5 is a view for explaining a process of calculating the coordinate values of a pair of offset points (V2+, V2−) for the point V2 among the points V1, V2, V3, and V4 illustrated in FIG. 4.

Referring to FIG. 5, equations of the two offset line pairs (L1+, L1−) and (L2+, L2−) are calculated as follows: two pairs of offset lines (L1+, L1−) and (L2+, L2−) extend parallel to line segments L1 and L2, respectively, the line segment L1 extends from the point V1 to the point V2, and the line segment L2 extends from the point V2 to the point V3, and the two pairs of offset lines (L1+, L1−) and (L2+, L2−) are separated a predetermined distance w from the two line segments L1 and L2. The 2-dimensional line transformation unit 32 (see FIG. 3) calculates the coordinate values of intersection points V2+ and V2− where the pair of offset lines (L1+, L1−) for the line segment L1 intersect the pair of offset lines (L2+, L2−) for the line segment L2, by using the equations of the two offset line pairs (L1+, L1−) and (L2+, L2−).

FIG. 6 is a view for explaining a method of calculating the coordinate values of the pair of offset points (V1+, V1−) for the point V1 among the points illustrated in FIG. 4.

Referring to FIG. 6, the 2-dimensional line transformation unit 32 calculates an equation of a line R which passes through the point V1 and is perpendicular to the line segment L1 whose end points are the points V1 and V2, and calculates the coordinate values of intersection points V1+ and V1− at which the pair of offset lines (L1+, L1−) intersect the line R, using the equations of the pair of offset lines (L1+, L1−) for the line segment L1 and the equation of the line R.

The coordinate values of offset point pairs (V3+, V3−) and (V4+, V4−) for the remaining points V3 and V4 can also be calculated using the above-described method. A detailed process of transforming a 2-dimensional line to a 2-dimensional polygon has been described above. However, it will also be understood by one of ordinary skill in the art that a 2-dimensional line can be transformed to a 2-dimensional polygon using different methods other than the above-described method. For example, points constructing a 2-dimensional line can be different points from or more points than the points V1, V2, V3, and V4 described above.

The 3-dimensional line transformation unit 33 transforms a 3-dimensional line among at least one line which is represented by the graphic data, to a 3-dimensional polygon, on the basis of the determination result of the line dimension determination unit 31. In more detail, the 3-dimensional line transformation unit 33 sequentially connects points that are separated a predetermined distance with respect to at least three predetermined directions, from each point constructing a 3-dimensional line among at least one line represented by the graphic data, on the basis of the determination result of the line dimension determination unit 31, thereby generating a polygon for the 3-dimensional line.

Here, the number of the predetermined directions depends on the shape of the polygon for the 3-dimensional line. A polygon which can ideally represent a 3-dimensional line has a cylindrical shape. However, when the polygon for the 3-dimensional line is set to a cylindrical shape, a large amount of calculation is required to generate the polygon since a lot of predetermined directions have to be considered. Meanwhile, if the polygon for the 3-dimensional line is a prism shape whose cross section is a regular triangle, a small amount of calculation is required to generate the polygon since only three predetermined directions need to be considered. Hereinafter, a case in which the polygon for the 3-dimensional line is a prism shape will be described. In particular, if the polygon for the 3-dimensional line is a prism shape, there may be three predetermined directions, which are extended using the 3-dimensional line as a central axis, and have an angle of 120° between each of the three predetermined directions.

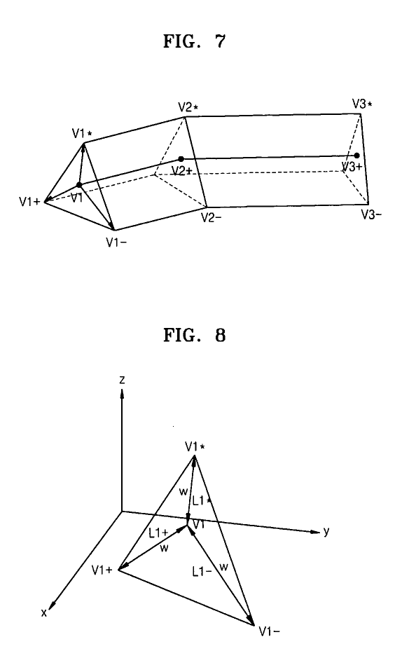

FIG. 7 is a view for explaining a line transformation method which is performed by the 3-dimensional line transformation unit 33 of the line transformation unit 211 illustrated in FIG. 3.

Referring to FIG. 7, the 3-dimensional line transformation unit 33 calculates the coordinate values of three points for each point constructing a 3-dimensional line, wherein the three points for each point are positioned on three lines which are separated a predetermined distance from the 3-dimensional line and have an angle of 120° between each other. In the current embodiment, points constructing the 3-dimensional line include a point V2 at which the 3-dimensional line is bent, and end points V1 and V3 of the 3-dimensional line. Also, the 3-dimensional line transformation unit 33 generates geometry data of a 3-dimensional polygon sequentially connecting points V1+, V1−, V1*, V2+, V2−, V2*, V3+, V3−, and V3* calculated for the points V1, V2, and V3 constructing the 3-dimensional line according to the above-described method, using the coordinate values of the points V1+, V1−, V1*, V2+, V2−, V2*, V3+, V3−, and V3*.

Here, sequentially connecting the points V1+, V1−, V1*, V2+, V2−, V2*, V3+, V3−, and V3* calculated for the points V1, V2, and V3 constructing the 3-dimensional line comprises connecting three points calculated for each point constructing the 3-dimensional line, and connecting most-neighboring points that are positioned in the same direction, for points calculated for the respective points constructing the 3-dimensional line.

Hereinafter, a process of calculating the coordinate values of the three points V1+, V1−, and V1* for the point V1 among the points illustrated in FIG. 7 will be described in detail.

FIG. 8 is a view for explaining a process of calculating the coordinate values of the three points V1+, V1−, and V1* calculated for the point V1 among the points illustrated in FIG. 7.

Referring to FIG. 8, the 3-dimensional line transformation unit 33 calculates an equation of a line L1+ which passes through the point V1 and has a left angle 120° with respect to a positive (+) direction of a Z-axis, and calculates the coordinate value of an intersection point V1+ at which the line L1+ intersects an xy plane and which is separated from the point V1 by a distance w, using the equation of the line L1+. Also, the 3-dimensional line transformation unit 33 calculates an equation of a line L1− which passes through the point V1 and has a right angle of 120° with respect to the positive (+) direction of the Z-axis, and calculates the coordinate value of an intersection point V1− at which the line L1− intersects the xy plane and which is separated from the point V1 by a distance w, using the equation of the line L1−. Also, the 3-dimensional line transformation unit 33 calculates the equation of a line L1* which passes through the point V1 and has a positive (+) direction of a z-axis and calculates the coordinate value of an intersection point V1* which is separated from the point V1 by a distance w by using the equation of the line L1*.

By using the above-described method, the coordinate values of three points (V2+, V2−, V2*) and (V3+, V3−, V3*) for each of the remaining points V2 and V3 can also be calculated. As described above, a process of transforming a 3-dimensional line to a 3-dimensional polygon has been described in detail. However, it will be understood by one of ordinary skill in the art that a 3-dimensional line can be transformed to a 3-dimensional polygon using different methods other than the method described above. For example, points constructing a 3-dimensional line can be different points from or more points than the points V1, V3, and V3 described above.

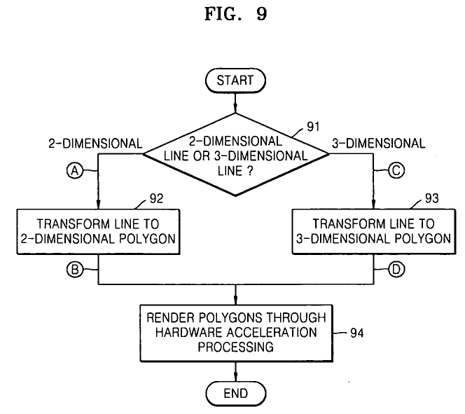

FIG. 9 is a flowchart of a graphic processing method according to an embodiment of the present invention.

Referring to FIG. 9, the graphic processing method includes operations that are sequentially processed by the graphics processing apparatus 21 illustrated in FIG. 2. Accordingly, the above descriptions for the graphics processing apparatus 21 illustrated in FIG. 2 will be also applied to the graphic processing method according to the current embodiment of the present invention.

In operation 91, the graphics processing apparatus 21 determines whether at least one line which is represented by graphic data is a 2-dimensional line or a 3-dimensional line. If the line represented by the graphic data is a 2-dimensional line, the process proceeds to operation 92, and if the line represented by the graphic data is a 3-dimensional line, the process proceeds to operation 93.

In operation 92, the graphics processing apparatus 21 transforms a 2-dimensional line among at least one line which is represented by the graphic data, to a 2-dimensional polygon.

In operation 93, the graphics processing apparatus 21 transforms a 3-dimensional line among at least one line which is represented by the graphic data, to a 3-dimensional polygon.

In operation 94, the graphics processing apparatus 21 renders at least one polygon which is represented by the graphic data and the polygon transformed in operation 92 or 93, through hardware acceleration processing.

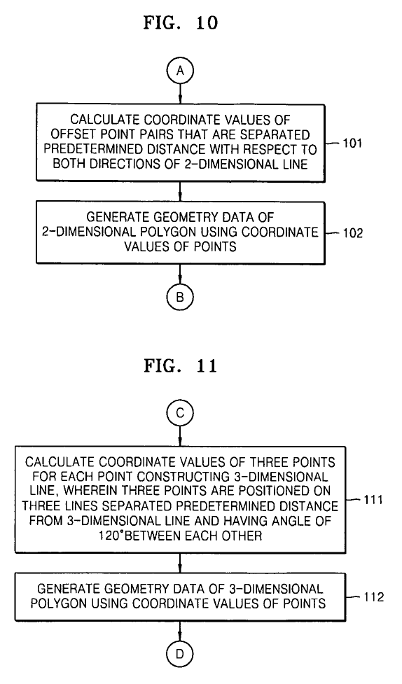

FIG. 10 is a detailed flowchart of operation 92 of the graphic processing method illustrated in FIG. 9, according to an embodiment of the present invention.

Referring to FIG. 10, in operation 101, the graphics processing apparatus 21 calculates the coordinate values of offset point pairs that are separated a predetermined distance with respect to both directions of a 2-dimensional line from each point, for each of a plurality of points constructing the 2-dimensional line.

In operation 102, the graphics processing apparatus 21 sequentially connects the points calculated in operation 101, using the coordinate values of the points, for each of the points constructing the 2-dimensional line, thereby generating geometry data of a 2-dimensional polygon.

FIG. 11 is a detailed flowchart of operation 93 of the graphic processing method illustrated in FIG. 9.

Referring to FIG. 11, in operation 111, the graphics processing apparatus 21 calculates the coordinate values of three points for each point constructing a 3-dimensional line, wherein the three points for each point are positioned on three lines which are separated a predetermined distance from the 3-dimensional line and have an angle of 120° between each other.

In operation 112, the graphics processing apparatus 21 sequentially connects the points for each point constructing the 3-dimensional line, using the coordinate values of the points calculated in operation 111, thereby generating geometry data of a 3-dimensional polygon. In detail, the graphic processing apparatus 21 connects three points corresponding to a point constructing the 3-dimensional line, and connects neighboring points among points corresponding to the remaining two points constructing the 3-dimensional line.

The embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

According to the present embodiments, by transforming a line represented by graphic data to a polygon and rendering the polygon through hardware acceleration processing, a graphics chip-set which supports only a polygon acceleration function can support a line acceleration function. That is, according to the present embodiments, by enabling a mobile terminal or the like which does not normally support a line acceleration function by using hardware to support the line acceleration function by using hardware, it is possible to more rapidly render lines of graphic data as in a mobile terminal supporting the line acceleration function.

Also, according to the present embodiments, since a line acceleration function is supported for 2-dimensional and 3-dimensional lines that are represented by graphic data, it is possible to more rapidly render graphic data (for example, graphic data for navigation screens) in which 2-dimensional images and 3-dimensional images coexist.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A graphic processing method comprising:
transforming at least one line represented by graphic data, to a polygon; and
rendering the polygon and at least one polygon represented by the graphic data.

2. The graphic processing method of claim 1, wherein the rendering of the polygon and the at least one polygon represented by the graphic data comprises rendering the polygon and the at least one polygon represented by the graphic data, through hardware acceleration processing.

3. The graphic processing method of claim 1, wherein the transforming of the at least one line to the polygon comprises connecting points that are separated a predetermined distance from each of a plurality of points constructing the at least one line, thereby generating the polygon for the at least one line.

4. The graphic processing method of claim 1, wherein the transforming of the at least one line to the polygon comprises:
determining whether the at least one line is a 2-dimensional line or a 3-dimensional line;
based on a determined result, transforming the 2-dimensional line to a 2-dimensional polygon; and
based on a determined result, transforming the 3-dimensional line to a 3-dimensional polygon.

5. The graphic processing method of claim 4, wherein the transforming of the 2-dimensional line to the 2-dimensional polygon comprises sequentially connecting points that are separated a predetermined distance in two predetermined directions from each of a plurality of points constructing the 2-dimensional line, thereby generating the 2-dimensional polygon.

6. The graphic processing method of claim 4, wherein the transforming of the 3-dimensional line to the 3-dimensional polygon comprises sequentially connecting points that are separated a predetermined distance in at least three predetermined directions from each of a plurality of points constructing the 3-dimensional line, thereby generating the 3-dimensional polygon.

7. A computer-readable recording medium having embodied thereon a program for executing a graphic processing method comprising:
transforming at least one line represented by graphic data, to a polygon; and
rendering the polygon and at least one polygon represented by the graphic data.

8. A graphics processing apparatus comprising:
a line transformation unit transforming at least one line represented by graphic data, to a polygon; and
a graphics engine rendering the polygon and at least one polygon represented by the graphic data.

9. The graphics processing apparatus of claim 8, wherein the graphic engine renders the polygon and the at least one polygon through hardware acceleration processing.

10. The graphics processing apparatus of claim 8, wherein the line transformation unit connects points that are separated a predetermined distance from each of a plurality of points constructing the at least one line, thereby generating the polygon for the at least one line.

11. The graphics processing apparatus of claim 8, wherein the line transformation unit comprises:
a line dimension determining unit determining whether the at least one line is a 2-dimensional line or a 3-dimensional line;
a 2-dimensional line transforming unit transforming the at least one line to a 2-dimensional polygon, based on a determined result; and
a 3-dimensional line transforming unit transforming the at least one line to a 3-dimensional polygon, based on a determined result.

12. The graphic processing apparatus of claim 11, wherein the 2-dimensional polygon transforming unit sequentially connects points that are separated a predetermined distance in two predetermined directions from each of a plurality of points constructing the 2-dimensional line, thereby generating the 2-dimensional polygon.

13. The graphic processing apparatus of claim 11, wherein the 3-dimensional polygon transforming unit sequentially connects points that are separated a predetermined distance in at least three predetermined directions from each of a plurality of points constructing the 3-dimensional line, thereby generating the 3-dimensional polygon.
